(19) United States
(12) Patent Application Publication
(10) Pub. No.: US 2024/0411050 A1
(43) Pub. Date: Dec. 12, 2024

(54) SYSTEM WITH AN ACOUSTIC SENSOR AND METHOD FOR REAL-TIME DETECTION OF METEOROLOGICAL DATA

(71) Applicant: Fraunhofer-Gesellschaft zur Förderung der angewandten Forschung e.V., München (DE)

(72) Inventors: Kevin HOCK, Ilmenau (DE); Christoph SLADECZEK, Ilmenau (DE); Mario SEIDENECK, Ilmenau (DE)

(73) Assignee: Fraunhofer-Gesellschaft zur Förderung der angewandten Forschung e.V., München (DE)

(21) Appl. No.: 18/807,969

(22) Filed: Aug. 17, 2024

Related U.S. Application Data
(63) Continuation of application No. PCT/EP2023/053155, filed on Feb. 9, 2023.

(30) Foreign Application Priority Data
Feb. 17, 2022 (DE) 102022201680.7

(51) Int. Cl. G01W 1/02; G01S 11/14; G01W 1/10; G01W 1/14

(52) U.S. Cl. CPC G01W 1/02; G01S 11/14; G01W 1/10; G01W 1/14

(57) ABSTRACT

A system is provided. The system includes one or more sound transducers, wherein the one or more sound transducers include at least one sound sensor configured to identify sound pressure information. In addition, the system includes a processing unit configured to determine weather information depending on the sound pressure information identified by the at least one sound sensor. The one or more sound transducers are configured to be installed on a mobile unit.

### CROSS-REFERENCES TO RELATED APPLICATIONS

This application is a continuation of copending International Application No. PCT/EP2023/053155, filed Feb. 9, 2023, which is incorporated herein by reference in its entirety, and additionally claims priority from German Application No. DE 10 2022 201 680.7, filed Feb. 17, 2022, which is incorporated herein by reference in its entirety.

The application concerns a system with an acoustic sensor and a method for real-time detection of meteorological data, e.g. for integration into a robotic system or for integration into unmanned or manned aircraft.

### BACKGROUND OF THE INVENTION

Weather forecasts are based on complex simulation models and rely on precise measurement data. Against the backdrop of climate change, the assessment of severe weather conditions and their local effects in the form of extreme weather is of particular importance. However, due to the stationary distribution of weather stations, there is a lack of spatial and temporal highly-resolution local weather information. In addition, some weather data is evaluated as an average over time and is not available in real-time. There is currently no concept that enables economical, resource-efficient, and infrastructure-independent measurement of weather information. A comprehensive distribution of sensors is not economically feasible with respect to energy consumption, maintenance, and upkeep costs.

Climate change is increasing the frequency of extreme weather events, natural disasters and anthropogenic environmental disasters and thus their potential risk. Symptoms for this are local severe weather events, the intensity of which leads to infrastructure being destroyed and to danger to life. In order to initiate targeted measures as early as possible to protect the population and critical infrastructure, local and high resolution meteorological real-time data is of crucial relevance.

Although, compared to global standards, Germany already operates a very dense sensor network of precipitation radars and precipitation measuring devices, so-called pluviometers, the exact detection of local weather events remain a major challenge. The reason for this is the high spatiotemporal variability of these weather phenomena. In conventional measurements by means of pluviometers, there are measurement errors such as wind, snow, or evaporation. Although precipitation radars achieve sufficient spatial and temporal resolution, it is much more difficult to determine the rain rate using radar reflectivity, as the drop size distribution is usually unknown. Furthermore, such radar systems are disturbed by shadowing effects or back-scattering of the radar beam. Initial research projects, such as the BNBF-funded “HoWa-innovativ” project [1], [3], have been carried out to address the low spatiotemporal resolution. Here, it was possible to draw conclusions about rain intensity based on the signal attenuation between radio relay antennas and cell towers. However, this method also relies on the radio network (CML) used, which currently roughly follows the population density. Consequently, less densely populated regions have a reduced spatial resolution of precipitation monitoring. The problem here is that, in addition to a reduced level of security in rural regions, the prevailing weather situation there can also be the cause of effects in densely populated areas. Furthermore, it has been shown that data processing is very complex and requires a special radio network (see [2], [3], [4]).

Hydrophones have already been used to measure precipitation on large bodies of water in depths of over one meter. Based on simple spectral analysis, hydro-acoustic signals caused by the impact of raindrops on the water surface were evaluated, and an approximation of the raindrop size is then attempted (see [5]). In another approach, the noise caused by raindrops was evaluated as a fixed trigger for exceeding a static threshold value (see [7]). Both approaches have in common that no intelligent conclusions could be drawn about characteristic features. In addition, both methods are location-specific and therefore cannot be used flexibly.

In addition to precipitation, local wind in the atmospheric boundary layer, the so-called peplosphere, is a key factor in the development of severe weather events. In the absence of meteorological date, measurement methods using drones have been evaluated in the art (drone=unmanned aircraft). Accordingly, differential pressure sensors are only suitable for aircraft-like drones in constant forward flight and with wind incidence within a limited angular range. Conventional mechanical anemometers, on the other hand, are limited to two-dimensional measurement and cannot be used due to their bulky design. Hot-wire anemometers are not subject to these disadvantages. However, they are very fragile and susceptible to damage. These types of sensors are not suitable for universal use in robotic systems or (unmanned) aircraft.

The conventional technology describes setups in which an ultrasonic anemometer is attached to a multicopter (see [6], [8]). However, such setups are very complex and can only be used to a limited extent. Furthermore, this type of ultrasonic sensor does not allow a fully automated, adaptive evaluation of the prevailing weather situation.

### SUMMARY

An embodiment may have a system, comprising: one or more sound transducers, wherein the one or more sound transducers comprise at least one sound sensor configured to identify sound pressure information, and a processing unit configured to determine weather information depending on the sound pressure information identified by the at least one sound sensor, wherein the one or more sound transducers are configured to be installed on a mobile unit.

Another embodiment may have a method, comprising: identifying sound pressure information by using at least one sound sensor, determining, by means of a processing unit, weather information depending on the sound pressure information identified by the at least one sound sensor, wherein one or more sound transducers comprising the at least one sound sensor are configured to be installed on a mobile unit.

Another embodiment may have a non-transitory digital storage medium having a computer program stored thereon to perform the method, comprising: identifying sound pressure information by using at least one sound sensor, determining, by means of a processing unit, weather information depending on the sound pressure information identified by the at least one sound sensor, wherein one or more sound transducers comprising the at least one sound sensor are configured to be installed on a mobile unit, when said computer program is run by a computer.

A system is provided. The system includes one or more sound transducers, wherein the one or more sound transducers include at least one sound sensor (e.g. a sound pressure sensor and/or a sound pressure gradient sensor) configured to identify (or determine or detect) sound pressure information (e.g. to identify sound pressure and/or to identify a sound pressure gradient). In addition, the system includes a processing unit configured to determine (or identify or detect) weather information depending on the sound pressure information identified by the at least one sound sensor. The one or more sound transducers are configured to be installed on a mobile unit. In addition, a method is provided. The method includes:
identifying sound pressure information by using at least one sound sensor.
determining, by means of a processing unit, weather information depending on the sound pressure information identified by the at least one sound sensor.

One or more sound transducers including the at least one sound sensor are configured to be installed on a mobile unit.

Furthermore, a computer program with a program code for performing the above-described method is provided.

In an embodiment, a novel sensor system performs spatiotemporal high-resolution monitoring of local weather events or sever weather events depending on an acoustic analysis.

Even though the weather situation is often colloquially described by the sound of its meteorological elements, acoustic sensors do not play a role in the measurement of weather phenomena. Weather data is typically measured in weather stations that have a fixed distribution across the country. Even if weather situations are large-scale events, the local impact is strongly characterized by location-dependent factors. There is a lack of high-resolution local data.

For a more reliable weather forecast, it is particularly relevant to know the current characteristics of precipitation and wind. Acoustic sensors in combination with tailored signal processing and AI have the potential to predict the strength of multiple prevailing meteorological elements based on acoustic behavior. Due to the possibility of miniaturization of acoustic sensors, some of the embodiments are based on using such an intelligent sensor system in combination with robotic systems or (unmanned) aircraft as a high-resolution weather measurement system. Such a measurement system can be independent of both location and infrastructure and can detect complex correlations in real-time, which opens up completely new application possibilities.

### BRIEF DESCRIPTION OF THE DRAWINGS

Embodiments of the present invention will be detailed subsequently referring to the appended drawings, in which:

FIG. 1 shows a system according to an embodiment.

FIG. 2 shows a system according to an embodiment, including a noise suppression module.

FIG. 3 shows a system according to an embodiment, in which the one or more sound transducers include at least one sound wave generator.

FIG. 4 shows a system according to an embodiment, further comprising a transmission interface and a reception interface.

### DETAILED DESCRIPTION OF THE INVENTION

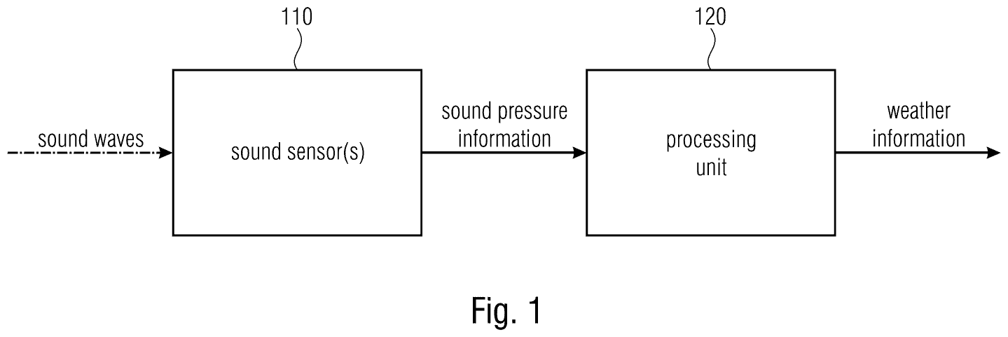

FIG. 1 shows a system according to an embodiment.

The system includes one or more sound transducers, wherein the one or more sound transducers include at least one sound sensor 110 configured to identify sound pressure information.

In addition, the system includes a processing unit 120 configured to determine weather information depending on the sound pressure information identified by the at least one sound sensor 110.

The one or more sound transducers are configured to be installed on a mobile unit.

For example, the sound sensor may be a sound pressure sensor and/or a sound pressure gradient sensor.

The identification of the sound pressure information may be an identification of a sound pressure and/or an identification of sound pressure gradients (a gradient of the sound pressure), for example.

For example, the mobile unit may be a moveable unit.

For example, the mobile unit may be a vehicle, such as an aircraft.

For example, the mobile or moveable unit may be a motorized unit, such as a (flying) drone, a motor aircraft, or a helicopter, but may also be a vehicle. For example, the mobile unit may also be a non-motorized vehicle, such as a hot air balloon or a glider.

However, the mobile unit may also be a wearable unit, such as a wearable module or a suitcase, having fixed thereon the at least one or more sound sensors.

According to an embodiment, e.g., the at least one sound sensor 110 may be configured to identify sound pressure information at least in the infrasound frequency range and in the audible sound frequency range and/or the at least one sound sensor 110 may be configured to identify sound pressure information at least in the audible sound frequency range and in the ultrasound frequency range.

In an embodiment, e.g., the at least one sound sensor 110 may be configured to identify sound pressure information in the infrasound frequency range and in the audible sound frequency range and in the ultrasound frequency range.

According to an embodiment, e.g., the at least one sound sensor 110 may be configured to identify sound pressure information in a frequency range f with 0≤f≤x, wherein 100 kHz≤x≤1 MHz.

In an embodiment, e.g., the processing unit 120 may be configured, for determining the weather information, to determine precipitation information and/or wind information and/or temperature information depending on the sound pressure information identified by the at least one sound sensor 110.

According to an embodiment, e.g., the processing unit 120 may be configured, for determining the weather information, to determine the precipitation information depending on the sound pressure information identified by the at least one sound sensor 110. In this case, e.g., the processing unit 120 may be configured, for determining the precipitation information, to determine at least one of the following precipitation information:
a precipitation type,
a drop size and/or a grain size of the precipitation,
a composition of the precipitation,
a kinetic energy of the precipitation,
a direction of origin of the precipitation.

In an embodiment, e.g., the processing unit may be configured, for determining the precipitation information, to determine at least the kinetic energy of the precipitation and/or at least a raindrop size of the precipitation. In this case, e.g., the processing unit 120 may be configured to determine an approximation of a cloud height and/or information concerning condensation nuclei and/or particle pollution of the air depending on the kinetic energy of the precipitation and/or depending on the raindrop size of the precipitation.

According to an embodiment, e.g., the processing unit 120 for determining the weather information, e.g., may be configured to determine the wind information depending on the sound pressure information identified by the at least one sound sensor 110. In this case, e.g., the processing unit 120 may be configured, for determining the wind information, to determine at least one of the following wind information:
a horizontal and/or vertical speed of the wind,
one or more directional vectors concerning the wind,
a wind type.

In an embodiment, e.g., the processing unit 120 for determining the weather information, e.g., may be configured to determine the temperature information depending on the sound pressure information identified by the at least one sound sensor 110. In this case, e.g., the processing unit 120 may be configured, for determining the temperature information, to determine an acoustic virtual temperature.

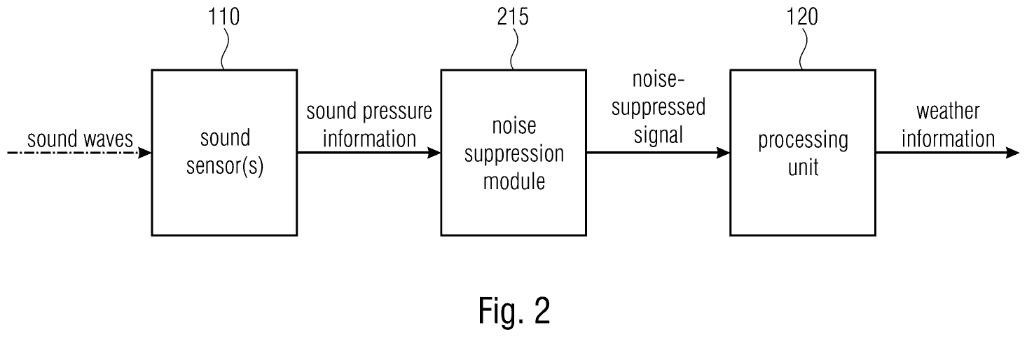

FIG. 2 shows a system according to an embodiment, further including a noise suppression module 215, e.g., configured to subject the sound pressure information identified by the at least one sound sensor 110 to a method for reducing noise so as to obtain one or more noise-suppressed sound signals. In this case, e.g., the noise suppression module 215 may be configured to transfer the noise-suppressed signal to the processing unit 120. Thus, e.g., the processing unit 120 may be configured to determine the weather information depending on the one or more noise-suppressed signals.

In an embodiment, e.g., the noise suppression module 215 may be configured to apply one or more noise suppression filters to at least one received sound signal comprising a signal representation of the sound pressure information identified by the at least one sound sensor 110 so as to determine the one or more noise-suppressed signals.

According to an embodiment, e.g., the processing unit 120 may be configured to determine the weather information depending on the sound pressure information identified by the at least one sound sensor 110 by means of a machine-trained module that has been trained by means of machine learning or by means of deep learning.

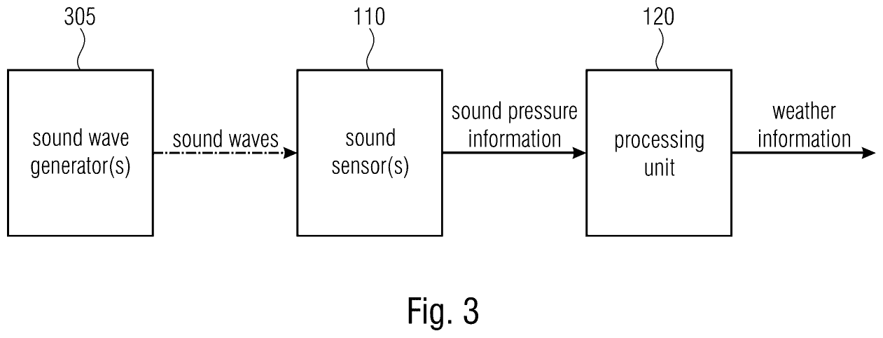

FIG. 3 shows a system according to an embodiment in which one or more sound transducers include at least one sound wave generator 305 for generating sound waves.

In a special embodiment, the system of FIG. 3 may additionally include the noise suppression module 215 of FIG. 2. In an alternative embodiment, the system of FIG. 3 may be configured to not include the noise suppression module 215 of FIG. 2.

According to an embodiment, e.g., the at least one sound wave generator 305 may be configured to identify sound pressure information, and/or the at least one sound sensor 110 may be configured to generate sound waves, for example.

In an embodiment, e.g., the at least one sound sensor 110 in the system may be arranged to receive sound pressure information depending on the sound waves generated by the at least one sound wave generator 305. In this case, e.g., the processing unit 120 may be configured to determine the weather information depending on the sound pressure information that depends on the sound waves generated by the at least one sound wave generator 305, and identified by the at least one sound sensor 110.

According to an embodiment, the at least one sound sensor 110 may be a plurality of sound sensors forming a two-dimensional or three-dimensional array. In this case, e.g., the processing unit 120 may be configured to determine, depending on the sound pressure information identified by the plurality of sound sensors and depending on the two or three-dimensional array of the plurality of sound sensors, direction-dependent information. In this case, e.g., the processing unit 120 may be configured to determine the weather information depending on the directional information.

In an embodiment, e.g., the processing unit 120 may be configured to determine the weather information depending on a distance between the at least one sound wave generator 305 and the at least one sound sensor 110.

According to an embodiment, the sound waves generated by the at least one sound wave generator 305 may be irradiated ultrasound waves and/or irradiated infrasound waves and/or irradiated audible sound waves, for example. In this case, the processing unit 120 may be configured, depending on the sound pressure information that depends on the ultrasound waves and/or the infrasound waves and/or the audible sound waves generated by the at least one sound wave generator 305, to determine a wind speed and/or a directional vector of a wind and/or an acoustic virtual temperature and/or a raindrop size and/or precipitation amount.

According to an embodiment, e.g., the processing unit 120 may be configured, for determining the wind speed and/or for determining the directional vector of the wind and/or for determining the acoustic virtual temperature and/for determining the raindrop size and/or for determining the precipitation amount, to determine at least one of the following precipitation information:
a precipitation type,
a drop size and/or grain size of the precipitation,
a composition of the precipitation,
a kinetic energy of the precipitation,
a direction of origin of the precipitation.

In an embodiment, e.g., the at least one processing unit 120 may be configured to determine aeroacoustic features of airflow by means of the sound pressure information identified by the at least one sound sensor 110 and to determine the weather information depending thereon.

According to an embodiment, e.g., the system may include a housing through which selectively guided airflow is caused.

In an embodiment, the one or more sound transducers may include at least one vibroacoustic sound receiver for identifying vibroacoustic sound waves. In this case, the processing unit 120 may be configured to determine the weather information depending on the vibroacoustic sound waves.

According to an embodiment, e.g., the noise suppression module 215 of FIG. 2 may be configured to perform the noise suppression depending on the vibroacoustic sound waves identified by the at least one vibroacoustic sound receiver.

For example, the processing unit 120 may be configured to determine information about precipitation depending on the vibroacoustic sound waves.

According to an embodiment, e.g., the processing unit 120 may be configured to recognize one or more acoustic events depending on the sound pressure information identified by the at least one sound sensor 110. The several acoustic events may be an occurrence of a special type of sound, for example. For example, a special sound may be recognized. The special sound may be any type of sound, such as the voice of a human being, a sound of an animal, a sound of a fire, etc.

In an embodiment, e.g., the processing unit 120 may be configured to classify the sound pressure information identified by the at least one sound sensor 110.

According to an embodiment, e.g., the processing unit 120 may be configured to recognize the one or more acoustic events by means of a machine-trained unit that has been trained by means of machine learning or by means of deep learning.

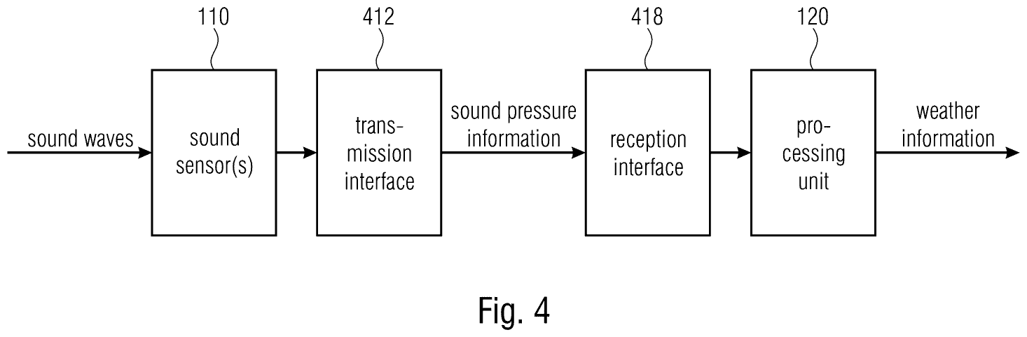

FIG. 4 shows a system according to an embodiment, further including a transmission interface 412 and a reception interface 418. For example, the transmission interface 412 may be configured to obtain the sound pressure information from the at least one sound sensor 110 and to transfer it to the reception interface 418. For example, the reception interface 418 may be configured to receive the sound pressure information from the transmission interface 412 and to transfer it to the processing unit 120.

In a special embodiment, e.g., the system of FIG. 4 may additionally include the noise suppression module 215 of FIG. 2. In an alternative embodiment, the system of FIG. 4 may be configured to not include the noise suppression module 215 of FIG. 2.

According to an embodiment, the transmission of the sound pressure information from the transmission interface 412 to the reception interface 418 may be carried out in a wireless manner, for example.

According to an embodiment, the transmission of the sound pressure information from the transmission interface 412 to the reception interface 418 may be carried out in a wired manner, for example.

According to an embodiment, e.g., the system may include the mobile unit. In this case, the at least one sound sensor 112 may be mounted on the mobile unit, for example.

In an embodiment, e.g., the system may include two or more mobile units including said mobile unit. In this case, the at least one sound sensor 110 may be at least two sound sensors, e.g., which may be mounted on different mobile units of the two or more mobile units.

According to an embodiment, the mobile unit may be an aircraft, for example.

In an embodiment, the mobile unit may be a mobile robotics unit, for example.

According to an embodiment, the mobile unit may be a flying drone, for example.

Special embodiments of the invention are described in the following.

In an embodiment, the wind speed and/or wind direction is determined with the aid of stationary or aircraft-supported or robot-supported acoustic sensor systems.

According to an embodiment, additionally or alternatively, an approximation of the precipitation amount and size of the raindrops as well as further parameters are derived.

In an embodiment, in parallel and/or independent therefrom, the local surroundings are monitored with respect to acoustic anomalies.

According to some embodiments, acoustic event recognition is provided.

In embodiments, the prevailing weather event and/or its effects may be transmitted, e.g. to the population and emergency management.

To realize these objects, embodiments provide a novel sensor system that is able to identify ultrasound and/or the audible frequency range (audible sound) and/or infrasound. In this case, the sensor system may be configured to face difficult conditions that result from the use at a stationary observation station or at a mobile robot-supported or (unmanned) aircraft-supported platform.

In embodiments, since an acoustic sensor may have a sensor design suitable for use, high-sensitive mechanical components are not required, as has been the case in existing anemometer types. The acoustic sensor may render obsolete the use of multiple sensors and may accordingly enable a more compact and maintenance-reduced construction.

In an embodiment, the measuring system in combination with AI-based signal processing (AI: artificial intelligence) may be able to recognize complex interactions of weather information from one or more signals. Thus, in an embodiment, e.g., the local weather situation may be analyzed in detail, and its direct effect on the surroundings may be monitored. For example, e.g., the water content of rivers or impending landslides may be recognized by means of water absorption of the ground.

According to some embodiments, e.g., the use of robot or aircraft platforms may be provided. This enables a flexible and quick use of the system fully independently of the local network infrastructure.

In an embodiment, several carrier platforms may be used simultaneously. In this way, e.g. a measuring network may be operated with a dynamically adjustable spatiotemporal resolution in each field of views.

Based on the stated multimode advances, there are significant advantages for the use in civil protection and disaster control. In particular, the indicated advances may overcome practice-related disadvantages of prevailing systems.

In embodiments, one or more of the following parameters may be determined in detail by means of the novel acoustic sensor system:

### Precipitation Parameters:

Type of precipitation/precipitation type (for example rain, snow, sleet and hail)
Drop or grain size(s) of the precipitation
Composition of the precipitation, e.g. sleet
Kinetic energy of the precipitation. In an embodiment, an approximation of the cloud height and/or conclusions about condensation nuclei or particle contamination of the air are determined) depending thereon
Direction of origin of the precipitation

### Wind Parameters:

Horizontal and/or vertical wind speed
Directional vector(s) concerning the wind
Type of wind/wind type (e.g. gusts, turbulent airflows, etc.) Temperature parameters (e.g. a virtual acoustic temperature, also referred to as acoustic virtual temperature).

Subsequently, two special embodiments of the sensor system are described, which can be considered on their own or united in a combined sensor system. Such a combination allows, e.g., detailed and additional meteorological parameters and correlations to be detected in real-time.

First, similarities between the two specific embodiments are described.

For example, in both embodiments, the acoustic sensor may comprise an electroacoustic sound transducer that is able to detect as great a frequency range as possible—from infrared sound across audible sound to ultrasound. For example, the detection range may cover a range of 0 Hz≤f≤x, wherein x may comprise a value of 100 kHz≤x≤1 MHz. For example, the detection range may cover 0 Hz≤f≤500 kHz.

In embodiments, e.g., an inventive sensor system may implement in both embodiments an adaptable method for reducing noise so as to prepare the acoustic signals for further signal processing. Through this, the inventive sensor system may be specifically adapted for the respective field of use. On the one hand, e.g., the information of the robot/air controllers about the currently active actuator system of the carrier system may be detected, acoustic filters may be derived therefrom, and the same may be applied. On the other hand, the weather measurement data of the acoustic sensor itself may be evaluated to generate filters or adapt filters. Through a special arrangement of the sound transducers, e.g., selectively guided air flow may be caused, and a noise filter may be derived by evaluating aeroacoustic properties. For example, shielding of certain sound transducer components of the new sensor system may be used to reduce disturbances.

Through interaction of the meteorological elements and the attachment of the sensor system, vibroacoustic processes may be created. This also applies for vibroacoustic effects due to a robotic or flight system. By utilizing the resulting vibroacoustic events, acoustic filters for reducing noise may be derived and applied to the acoustic signals of the sound receivers.

The first embodiment concerns an acoustic sensor system with acoustic measuring paths.

For example, the first embodiment may consist of a combination of a sound receiver and a sound source or a two-dimensional or three-dimensional array of these sound transducers. In this way, dynamic adaptive directional characteristics of the sound receiver may be achieved by means of digital signal processing. In special embodiments, sound sources in the form of electroacoustic actuators may also function as sound receivers and vice versa. Thus, the electroacoustic sound transducers may be driven or used dynamically as an actuator or as a sensor according to the situation.

In an embodiment, wind is measured, e.g., across one or more ultrasound measuring paths consisting of an ultrasound transmitter and an opposite ultrasound receiver in a specified distance. These measuring paths form a corresponding ultrasound array in two-dimensional or three-dimensional spatial orientations, for example. By outputting signals, such as pulse-like signals, sweeps, individual sinusoidal tones, and/or signal (pseudo) random sequences along the measuring paths, the wind speed as well as the directional vector of the wind are derived. Furthermore, the virtual acoustic temperature may be derived. For example, the use of a multi-dimensional orientation may be used in parallel to validate the measuring data.

According to an embodiment, e.g., the wind is measured across one or more infrasound measuring paths consisting of an infrasound transmitter and an opposite infrasound receiver in a specified distance. These measuring paths form a corresponding infrasound array in two-dimensional or three-dimensional spatial orientations, for example. By outputting signals, such as pulse-like signals, sweeps, individual sinusoidal tones, and/or signal (pseudo) random sequences along the measuring paths, the wind speed as well as the directional vector of the wind are derived. Furthermore, the virtual acoustic temperature may be derived. For example, the use of multidimensional orientation may be used in parallel to validate the measuring data.

In an embodiment, the wind is measured across one or more audible sound measuring paths consisting of an audible sound transmitter and an opposite audible sound receiver in a specified distance. These measuring paths form a corresponding infrasound array in two-dimensional or three-dimensional spatial orientations, for example. By outputting signals, such as pulse-like signals, sweeps, individual sinusoidal tones, and/or signal (pseudo) random sequences along the measuring paths, the wind speed as well as the directional vector of the wind are derived. Furthermore, the virtual acoustic temperature may be derived. For example, the use of a multi-dimensional orientation may be used in parallel to validate the measuring data.

According to a further embodiment, a combination of two or three of the above three variations (ultrasound, infrasound, audible sound) is provided.

To detect precipitation, the same ultrasound transducers and/or infrasound transducers and/or audible sound transducers may be used as in the measurement of wind. The frequency of the radiated ultrasound signals and/or infrasound signals and/or audible sound signals may be varied. Due to the interaction of the raindrop size and the respective wavelength of the ultrasound wave and/or infrasound wave and/or audible sound wave, scattering and attenuation effects are created. Thus, the raindrop size and the precipitation amount may be approximated. The variation of the frequency may be used to detect the drop sized distribution more precisely.

The second embodiment concerns an acoustic sensor system without dedicated measuring paths.

This embodiment may consist of a single sound transceiver or a two-dimensional or three-dimensional array, for example. In this way, dynamic adaptive directional characteristic of the sound transceiver may be achieved by means of digital signal processing. Furthermore, e.g., the embodiment may comprise a vibroacoustic sound receiver so as to detect oscillations of the robotic system or the aircraft.

To measure the wind, e.g., sound receivers for infrasound, audible sound and ultrasound may be used. Due to the interaction of the airflow by means of the wind and the special housing and/or the arrangement of the sound receivers, selectively guided airflow may be caused and/or aeroacoustics characteristics of the airflow may be detected or derived. Through cascaded signal processing, information about the prevailing wind, such as wind speed and direction, as well as turbulent winds, may be detected and analyzed in this way.

In the application of the novel sensor system, the precipitation strikes the sensor housing and possibly also components of the carrier system nearby. The signal analysis of the acoustic sensor components may be used to determine information about the precipitation, such as the type and the composition.

In addition to measuring meteorological parameters, the acoustic data of all sounds receivers of both embodiments may be used for acoustic automatic recognition or detection of acoustic events. To this end, the sensor system may comprise algorithms of machine learning and/or deep learning, for example. In this way, it is possible to obtain further information about the weather event as well as to recognize the occurrence of at least one signal class to be monitored. Conceivable application cases could be the monitoring of surroundings with respect to the (direct) effects of weather events, in addition to the detection of human speech, animal noise, or gas leakage. Thus, e.g., river courses and/or dams and/or the terrain may be monitored with respect to signs of landslides.

In embodiments, the processed sensor data may be provided by wired and/or a wireless interface. For example, if there is no connection, according to an embodiment, the data may be buffered/stored for later transmission. Furthermore, this data may be the starting point for autonomous reactions of the robotic systems or the unmanned aircraft.

There are possibilities of use for authorities and organizations with security tasks as well as metrological research establishments and operators of critical infrastructures. There is a further application possibility with respect to providers of vertical mobility solutions, since a corresponding sensor system is of significance for weather forecast. An inventive acoustic sensor system may also be used in combination sensors, such as in combination with dangerous material sensor systems.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile.

A further embodiment of the inventive method thus is a data stream or a sequence of signals representing the computer program for performing any of the methods described herein.

The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### Glossary

Anemometer An anemometer is a measuring device for measuring local wind speed. An anemometer may have different designs (mechanical anemometer), hot-wire anemometer, and more.
CML Commercial microwave link (CML) describes commercial directional radio paths between radio towers, which mostly operate with a frequency of between 187 and 27 GHz. This density distribution of this radio network approximately follows the population density.
Peplosphere The atmospheric boundary layer, also referred to as peplosphere, describes the lowermost layer of the atmosphere of the earth directly adjacent to the surface of the earth.

### BIBLIOGRAPHY

[1] Bundesministerium für Bildung und Forschung. Hochwasserfrühwarnung für kleine Einzugsgebiete mit innovativen Methoden der Niederschlagsmessung und—vorhersage (HoWa-innovativ) (German Federal Ministry of Education and Research. Early flood warning for small catchment areas with innovative methods of precipitation measurement and forecasting (HoWa-innovativ)); retrieved on Jan. 26, 2022; url: https://www.sifo.de/sifo/shareddocs/Downloads/files/projektumriss_howa-innovativ.pdf?__blob=publicationFile&v=1
[2] Christian Chwala and Harald Kunstmann. “Commercial microwave link networks for rainfall observation: Assessment of the current status and future challenges”. In: WIREs Water (February 2019)
[3] Maximilian Graf et al. “Opportunistische Erfassung meteorologischer Größen—Regenmessung im Mobilfunknetz (Opportunistic recording of meteorological variables—rain measurement in the mobile network)”. In: Physik in unserer Zeit 2/2021 (2021), pages 88-93
[4] Hagit Messer et al. “Environmental Monitoring by Wireless Communication Networks”. In: Science 312 (2016), page 713
[5] Jeffrey A. Nystuen et al. “A Comparison of Automatic Rain Gauges”. In: Journal of Atmospheric and Oceanic Technology 13 (1996), pages 62-73
[6] Samuel Prudden et al. “Measuring Wind with Small Unmanned Aircraft Systems”. In: Journal of Wind Engineering and Industrial Aerodynamics 176 (2018), pages 197-210
[7] Marius Telişcǎ. “Acoustic Rain Gauge”. Patent RO 123153 B1. May 13, 2010
[8] William Thiele et al. “Towards accurate and practical drone-based wind measurements with an ultrasonic anemometer”. In: Atmospheric Measurement Techniques Discussions (2020)
[9] RO 123153 B1.
[10] EP 3071999 A.
[11] RU 2016112082 A.
[12] CN 212008640 U.
[13] U.S. Pat. No. 5,528,224 A.
[14] KR 101961633 B1.
[15] CN 111916089 A.
[16] CA 1104245 A.

1. System, comprising:
one or more sound transducers, wherein the one or more sound transducers comprise at least one sound sensor configured to identify sound pressure information, and
a processing unit configured to determine weather information depending on the sound pressure information identified by the at least one sound sensor,
wherein the one or more sound transducers are configured to be installed on a mobile unit.

2. System according to claim 1,
wherein the at least one sound sensor is configured to identify sound pressure information at least in the infrasound frequency range and in the audible sound frequency range, and/or
wherein the at least one sound sensor is configured to identify sound pressure information at least in the audible sound range and in the ultrasound frequency range.

3. System according to claim 2,
wherein the at least one sound sensor is configured to identify sound pressure information in the infrasound frequency range and in the audible sound frequency range and in the ultrasound frequency range.

4. System according to claim 1,
wherein the at least one sound sensor is configured to identify sound pressure information in a frequency range f with 0≤f≤x, wherein 100 kHz≤x≤1 MHz.

5. System according to claim 1,
wherein the processing unit is configured, for determining the weather information, to determine precipitation information and/or wind information and/or temperature information depending on the sound pressure information identified by the at least one sound sensor.

6. System according to claim 5,
wherein the processing unit for determining the weather information is configured to determine the precipitation information depending on the sound pressure information identified by the at least one sound sensor,
wherein the processing unit is configured, for determining the precipitation information, to determine at least one of the following precipitation information:
a precipitation type,
a drop size and/or a grain size of the precipitation,
a composition of the precipitation,
a kinetic energy of the precipitation,
a direction of origin of the precipitation.

7. System according to claim 6,
wherein the processing unit is configured, for determining the precipitation information, to determine at least the kinetic energy of the precipitation and/or at least a raindrop size of the precipitation,
wherein the processing unit is configured to determine an approximation of a cloud height and/or information concerning condensation nuclei and/or particle pollution of the air depending on the kinetic energy of the precipitation and/or depending on the raindrop size of the precipitation.

8. System according to claim 5,
wherein the processing unit for determining the weather information is configured to determine the wind information depending on the sound pressure information identified by the at least one sound sensor,
wherein the processing unit is configured, for the determining the wind information, to determine at least one of the following wind information:
a horizontal and/or vertical speed of the wind,
one or more directional vectors concerning the wind,
a wind type.

9. System according to claim 5,
wherein the processing unit for determining the weather information is configured to determine the temperature information depending on the sound pressure information identified by the at least one sound sensor,
wherein the processing unit is configured, for determining the temperature information, to determine an acoustic virtual temperature.

10. System according to claim 1,
wherein the system comprises a noise suppression module configured to subject the sound pressure information identified by the at least one sound sensor to a method for reducing noise so as to acquire one or more noise-suppressed sound signals,
wherein the noise suppression module is configured to transfer the one or more noise-suppressed signals to the processing unit,
wherein the processing unit is configured to determine the weather information depending on the one or more noise-suppressed signals.

11. System according to claim 10, wherein the noise suppression module is configured to apply one or more noise suppression filters to at least one received sound signal comprising a signal representation of the sound pressure information identified by the at least one sound sensor so as to determine the one or more noise-suppressed signals.

12. System according to claim 1,
wherein the processing unit is configured to determine the weather information depending on the sound pressure information identified by the at least one sound sensor by means of a machine-trained module that has been trained by means of machine learning or by means of deep learning.

13. System according to claim 1,
wherein the one or more sound transducers comprise at least one sound wave generator for generating sound waves.

14. System according to claim 13,
wherein the at least one sound wave generator is further configured to identify sound pressure information, and/or
wherein the at least one sound sensor is further configured to generate sound waves.

15. System according to claim 13,
wherein the at least one sound sensor in the system is arranged to identify sound pressure information depending on the sound waves generated by the at least one sound wave generator,
wherein the processing unit is configured to determine the weather information depending on the sound pressure information that depends on the sound waves generated by the at least one sound wave generator, and identified by the at least one sound sensor.

16. System according to claim 15,
wherein the at least one sound sensor is a plurality of sound sensors forming a two-dimensional or three-dimensional array,
wherein the processing unit is configured to determine directional-dependent information depending on the sound pressure information identified by the plurality of sound sensors and depending on the two or three-dimensional array of the plurality of sound sensors, and
wherein the processing unit is configured to determine the weather information depending on the directional information.

17. System according to claim 15,
wherein the processing unit is configured to determine the weather information depending on a distance between the at least one sound wave generator and the at least one sound sensor.

18. System according to claim 15,
wherein the sound waves generated by the at least one sound wave generator are irradiated ultrasound waves and/or irradiated infrasound waves and/or irradiated audible sound waves,
wherein the processing unit is configured, depending on the sound pressure information that depends on the ultrasound waves and/or the infrasound waves and/or the audible soundwaves generated by the at least one sound wave generator, to determine a wind speed and/or a directional vector of a wind and/or an acoustic virtual temperature and/or a raindrop size and/or precipitation amount.

19. System according to claim 18,
wherein the processing unit is configured, for determining the wind speed and/or for determining the directional vector of the wind and/or for determining the acoustic virtual temperature and/for determining the raindrop size and/or for determining the precipitation amount, to determine at least one of the following precipitation information:
a precipitation type,
a drop size and/or grain size of the precipitation,
a composition of the precipitation,
a kinetic energy of the precipitation,
a direction of origin of the precipitation.

20. System according to claim 1,
wherein the at least one processing unit is configured to determine aeroacoustic features of airflow by means of the sound pressure information identified by the at least one sound sensor and to determine the weather information depending thereon.

21. System according to claim 1,
wherein the system comprises a housing through which selectively guided airflow is caused.

22. System according to claim 1,
wherein the one or more sound transducers comprise at least one vibroacoustic sound receiver for identifying vibroacoustic sound waves,
wherein the processing unit is configured to determine the weather information depending on the vibroacoustic sound waves.

23. System according claim 10,
wherein the one or more sound transducers comprise at least one vibroacoustic sound receiver for identifying vibroacoustic sound waves,
wherein the processing unit is configured to determine the weather information depending on the vibroacoustic sound waves,
wherein the noise suppression module is configured to perform the noise suppression depending on the vibroacoustic sound waves identified by the at least one vibroacoustic sound receiver.

24. System according to claim 22,
wherein the processing unit is configured to determine information about precipitation depending on the vibroacoustic sound waves.

25. System according to claim 1,
wherein the processing unit is configured to recognize one or more acoustic events depending on the sound pressure information identified by the at least one sound sensor.

26. System according to claim 1,
wherein the processing unit is configured to classify the sound pressure information identified by the at least one sound sensor.

27. System according to claim 25,
wherein the processing unit is configured to recognize the one or more acoustic events by means of a machine-trained unit that has been trained by means of machine learning or deep learning.

28. System according to claim 1,
wherein the system comprises a transmission interface configured to receive the sound pressure information from the at least one sound sensor and to transfer it to a reception interface,
wherein the system comprises the reception interface configured to receive the sound pressure information from the transmission interface and to transfer it to the processing unit.

29. System according to claim 28,
wherein the transmission of the sound pressure information from the transmission interface to the reception interface is carried out in a wireless manner.

30. System according to claim 28,
wherein the transmission of the sound pressure information from the transmission interface to the reception interface is carried out in a wired manner.

31. System according to claim 1,
wherein the system comprises the mobile unit,
wherein the at least one sound sensor is mounted on the mobile unit.

32. System according to claim 31,
wherein the system comprises two or more mobile units comprising said mobile unit,
wherein the at least one sound sensor is at least two sound sensors mounted on different mobile units of the two or more mobile units.

33. System according to claim 1,
wherein the mobile unit is an aircraft.

34. System according to claim 1,
wherein the mobile unit is a mobile robotic unit.

35. System according to claim 1,
wherein the mobile unit is a flying drone.

36. Method, comprising:
identifying sound pressure information by using at least one sound sensor,
determining, by means of a processing unit, weather information depending on the sound pressure information identified by the at least one sound sensor,
wherein one or more sound transducers comprising the at least one sound sensor are configured to be installed on a mobile unit.

37. A non-transitory digital storage medium having a computer program stored thereon to perform the method, comprising:
identifying sound pressure information by using at least one sound sensor,
determining, by means of a processing unit, weather information depending on the sound pressure information identified by the at least one sound sensor,
wherein one or more sound transducers comprising the at least one sound sensor are configured to be installed on a mobile unit,
when said computer program is run by a computer.
